(19) United States
(12) Patent Application Publication
(10) Pub. No.: US 2006/0114529 A1
(43) Pub. Date: Jun. 1, 2006

(54) Terminal apparatus for transforming print image on a screen by means of print preview function and method thereof

(75) Inventor: Myoung-Jin Oh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/272,679

(22) Filed: Nov. 15, 2005

(30) Foreign Application Priority Data
Nov. 29, 2004 (KR) 2004-98650

(51) Int. Cl. G06K 15/02

(52) U.S. Cl. 358/527; 358/1.2

(57) ABSTRACT

A terminal apparatus transforms an image to be printed by means of a preview function. The terminal apparatus has a user interface unit for receiving a user selection command, a preview screen generating unit for generating a preview image on a display screen by receiving a preview screen display command for a predetermined image through the user interface unit, a display unit for displaying the preview screen, and a control unit for controlling the preview screen generating unit to move the image displayed on the preview screen in a predetermined direction based on a move command entered through the user interface unit. Thus, images of desired shape can be obtained all the time.

### CROSS-REFERENCE TO RELATED APPLICATIONS

This application claims the benefit under 35 U.S.C. § 119(a) of Korean Patent Application No. 2004-98650, filed on Nov. 29, 2004, the entire content of which is hereby incorporated herein by reference.

### BACKGROUND OF THE INVENTION

1. Field of the Invention

The present invention relates to a terminal apparatus for displaying a print image on a preview screen and a method thereof. More particularly, the present invention relates to a terminal apparatus for moving an image on a preview screen, and printing the moved image and method thereof.

2. Description of the Related Art

As computers have continued to become widespread, peripheral apparatuses such as printers have also continued to become more popular. As a result, high-quality laser printers for efficient printing are now used at home.

Generally, a user enters a printing command into a terminal apparatus after writing a specific kind of document on a terminal apparatus, and the terminal apparatus transmits printing data to the printer according to a printer driver program, which completes the printing process. Meanwhile, the user might take advantage of a print preview function to compare the image that the user has written with the image to be printed out by the printer. In other words, the user may view an image to be printed on a screen of a terminal apparatus prior to the transmission of print data to the printer, by selecting a preview function on the application program or the printer driver program which was used in the preparation of the document.

Recently, the use of digital cameras, cellular phone cameras, and the like has been significantly increasing. A printer can print out images taken by such a camera, unlike a typical film-based optical camera. Recent high-efficiency color printers have a borderless print function that enables an image to be printed out without blank space on printing paper.

FIGS. 1A and 1B are examples of preview screens according to a conventional terminal apparatus. Initially, FIG. 1A shows an original image 10 displayed on a preview screen 20. Referring to FIG. 1A, the original image 10 is arranged and displayed on the upper left side of the preview screen 20. If a print command is entered under this circumstance, then needless blank space is printed out, in addition to the original image 10. It is burdensome for a user to cut off the blank space in order to use the printout as a photograph or the like. Therefore, in a printer having a borderless print function, a user can select a borderless print function on the preview screen to eliminate the need to cut off blank space.

FIG. 1B shows the preview screen 20 displaying an enlarged image 10′ which is produced by selecting a borderless print function. However, part of the original image might not fit within the printing area if the aspect ratio of the original image is different from that of the printing paper, as shown in FIG. 1B. Thus, the printer may print only part of an image, and the user has no control over which specific part of an image is cut off irrespective of the user's desires.

Accordingly, there is a need for an improved apparatus for previewing and printing an image, and a method of doing the same.

### SUMMARY OF THE INVENTION

An aspect of the present invention is to address at least the above problems and/or disadvantages and to provide at least the advantages described below. Accordingly, an aspect of the present invention is to provide a terminal apparatus and a method for printing a desired part of an image, by moving the location of the original image on the preview screen.

According to an exemplary embodiment of the present invention, a terminal apparatus comprises a user interface unit for receiving a user selection command, a preview screen generating unit for generating a preview image on a display screen by receiving a preview screen display command for a predetermined image through the user interface unit, a display unit for displaying the preview screen, and a control unit for controlling the preview screen generating unit to move the image displayed on the preview screen in a predetermined direction based on a move command entered through the user interface unit.

The terminal apparatus may further comprise a data processing unit for converting image data displayed on the preview screen into predetermined print data based on a print command entered through the user interface unit, and a printer interface unit connected to an external printer for transmitting the print data to the printer.

The control unit may control the preview screen generating unit to transform the state of the image displayed on the preview screen based on a transform command entered for transforming the image into the predetermined state.

The control unit may control the preview screen generating unit to make one of the width and length of the image substantially identical with one of the width and length of the printing paper to be printed based on a borderless display command entered for the image displayed on the preview screen.

The control unit may control the preview screen generating unit to display a plurality of substantially identical images successively on the preview screen based on a plural display command entered for the image displayed on the preview screen.

The preview screen generating unit may generate the preview screen by using one of the predetermined application program or the printer driver program.

According to another exemplary embodiment of the present invention, a method for printing via an external printer comprises the steps of generating a preview screen for an image, moving the image on the preview screen based on an entered location move command, converting the moved image data into print data that is recognizable by the printer, and transmitting the print data to the printer.

The method may further comprise the step of transforming the size of the image displayed on the preview screen by a predetermined transformation ratio based on a size transform command entered for the image displayed on the preview screen.

The method may further comprise the steps of displaying the transformed image to make one of the width and length of the image substantially identical with one of the width and length of the printing paper to be printed based on a borderless display command entered for the image displayed on the preview screen, and moving the image displayed on the preview screen in a predetermined direction based on the entered move command.

The method may further comprises the steps of displaying a plurality of substantially identical images successively on the preview screen based on a plural display command entered for the image displayed on the preview screen, and moving the image displayed on the preview screen in a predetermined direction based on the entered move command.

The step of generating a preview screen may be accomplished by one of a predetermined application program or a printer driver program.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIGS. 1A and 1B are a schematic diagrams of a preview screen according to a conventional terminal apparatus;

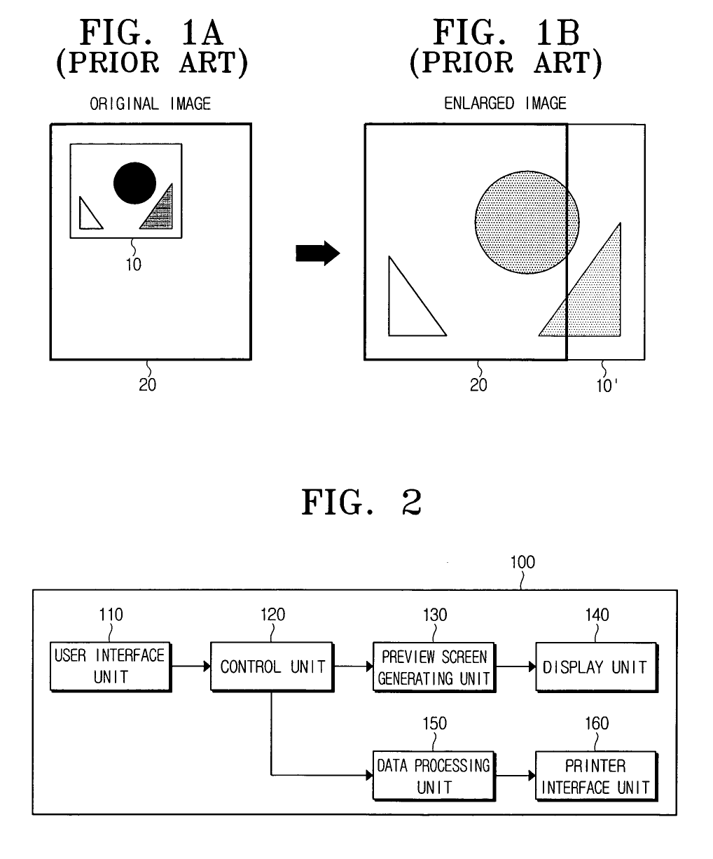

FIG. 2 is a block diagram of a structure of a terminal apparatus according to an exemplary embodiment of the present invention;

FIGS. 3A, 3B, 4A, 4B, 5A and 5B are schematic diagrams of examples of preview screens in the terminal apparatus shown in FIG. 2; and

FIG. 6 is a flowchart of a method of printing according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

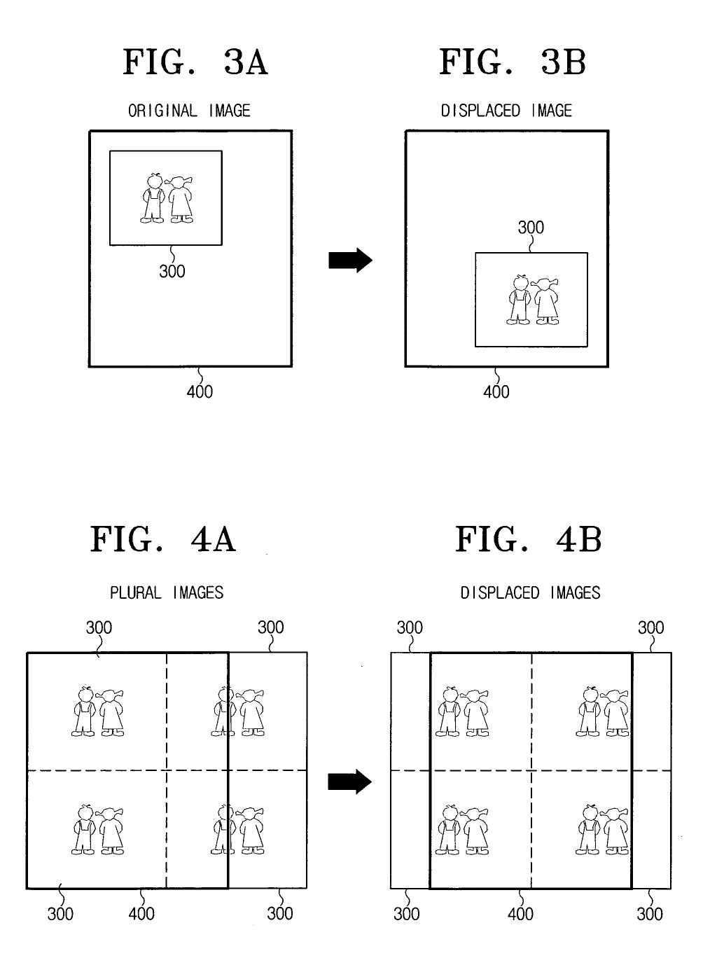

FIG. 2 is a block diagram of the structure of a terminal apparatus according to an exemplary embodiment of the present invention. As shown in FIG. 2, a terminal apparatus 100 includes a user interface unit 110, a control unit 120, a preview screen generating unit 130, a display unit 140, a data processing unit 150, and a printer interface unit 160. The terminal apparatus 100 may be a personal computer or any other apparatus which can be connected to a printer and can carry out printing processes, such as notebook PCs, personal digital assistants (PDAs), digital cameras, or the like.

The user interface unit 110 receives a predetermined select command from the user of the terminal apparatus 100. The user can enter various kinds of select commands such as a print command, a preview screen display command, an image transform command and a location move command, or the like through the user interface unit 110. If the user enters a preview screen display command for a specific document, then the user interface unit 110 informs the control unit 120 of this event. If the user installs a printer driver program, the user interface window might be displayed on the screen, which can be entered by one of the foregoing select commands.

When informed that a preview screen display command has been entered, the control unit 120 controls the preview screen generating unit 130 to generate a preview screen which displays a document the user has created. The preview screen generating unit 130 might generate the preview screen by a printer driver program, or by the application program which was used to create a document. The newly generated preview screen is displayed on the screen by the display unit 140.

The preview screen is laid out to display an image of printing paper and a document to be printed. A printing process is implemented by means of a print command. In addition, a print area might stand out with a dotted line or a different color from a non-print area.

At the same time, various kinds of buttons might be displayed on the preview screen, such as a location move button, an image size transform button, a printing paper setting button, and the like. Thus, the user may select one of the various buttons displayed on the preview screen, and then the user interface unit 110 recognizes and communicates the selected button to the control unit 120. Therefore, it is not necessary for the user to return to the application program. Then, the control unit 120 controls the preview screen generating unit 130 so as to transform the image or print the image as displayed on the preview screen. The location move button can be manipulated in at least four different directions, that is, top, bottom, left and right.

The control unit 120 controls the preview screen generating unit 130 to move images displayed on the screen based on a location move command entered for the image displayed on the preview screen through the user interface unit 110. The preview screen generating unit 130 transforms the preview screen to move the location of the image within the print area of the preview screen based on the location move command.

The data processing unit 150 converts the document data into print data comprising specific commands which the printer recognizes upon receiving a print command from the user. The print data is preferably converted in the data processing unit 150, which is connectable to an external printer (not shown) via the printer interface unit 160. The printer interface 160 may be a serial interface (including a universal serial bus, or USB, interface), or may be a parallel interface for performing data communication with an external printer. A video controller (not shown) of a printer (not shown) interprets and converts the print data into a bitmap image by a specific emulation language. Thus, a converted image is transmitted to an engine controller (not shown) to be printed out on paper.

The control unit 120 controls the data processing unit 150 to generate print data for moved image data displayed on the preview screen based on an entered print command. The user can easily operate location move buttons to move images displayed on the preview screen, and then print the moved image.

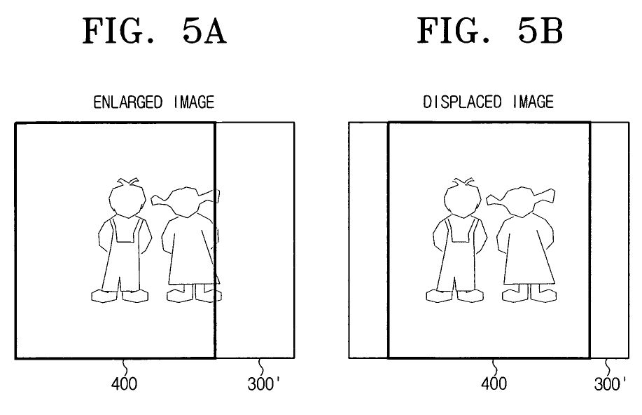

FIGS. 3A and 3B are schematic diagrams that illustrate examples of preview screens in the terminal apparatus according to a location move command. Initially, FIG. 3A shows the preview screen 400 that displays the original image 300. With reference to FIG. 3A, the original image 300 is displayed at the upper left side of the preview screen. In this case, the user can move the original image 300 based on the location move command. As shown in FIG. 3B, the original image 300 is moved to the right and down, and displayed as the user operates the right move button and the bottom move button. Thus, the moved image can be printed as shown in FIG. 3B based on a print command from the user.

FIGS. 4A and 4B are schematic diagrams that illustrate another example of preview screens in the terminal apparatus according to a location move command. Initially, FIG. 4A shows the preview screen 400 that successively displays plural, substantially identical, original images 300.

The successive, plural, substantially identical, original images 300 can be generated as shown in FIG. 4A when the user enters the plural display command for original image 300 displayed on the preview screen as shown in FIG. 3A. When the entire image cannot be printed on one piece of printing paper, which is caused by a size limitation, it is unavoidable to cut off part of the image displayed on the preview screen 400. In the illustrated embodiment, the right part of the image is cut off. Thus, if the original image 300 is a photographic image, the photograph cannot be used to photograph an individual in the right part of the photograph.

However, the user may easily transform an image to be printed by pushing the top, bottom, left, and right location move buttons to move the image as desired, according to the exemplary embodiments of the present invention. FIG. 4B shows the preview screen 400 after pushing the right location move button. As a result of pushing the right location move button, the photograph may easily be used to photograph an individual in the right part of the photograph.

FIGS. 5A and 5B are schematic diagrams that illustrate another example of the preview screen in the terminal apparatus according to a location move command. Initially, FIG. 5A shows the preview screen 400 based on an entered borderless print command, which enlarges the original image 300 and removes blank printing paper. The enlarged image 300′ can be displayed as shown in FIG. 5A when the user enters a borderless print command for the original image 300 displayed on the preview screen as shown in FIG. 3A. In this case, the size of enlarged image 300′ depends on the size of printing paper. That is, in order to remove blank printing paper, it is necessary to make one of the width or length of the enlarged image 300′ substantially identical with one of width or length of the printing paper. FIG. 5A shows an enlarged image 300′ in which the length of the enlarged image 300′ is larger than the size of the printing paper. That is, the width of the enlarged image 300′ is beyond the edges of the printing paper. Therefore, if the original image 300 is a photographic image with an individual in the right part of the photograph, the photograph will not show all individuals if printed by borderless printing.

The user can transform the enlarged image 300′ displayed on the preview screen 400 by means of a location move command. That is, as shown in FIG. 5B, all the individuals might be within the preview screen 400 after moving the enlarged image 300′ to the right by means of the right location move button. Thus, the user can select the part of the preview screen 400 to be printed.

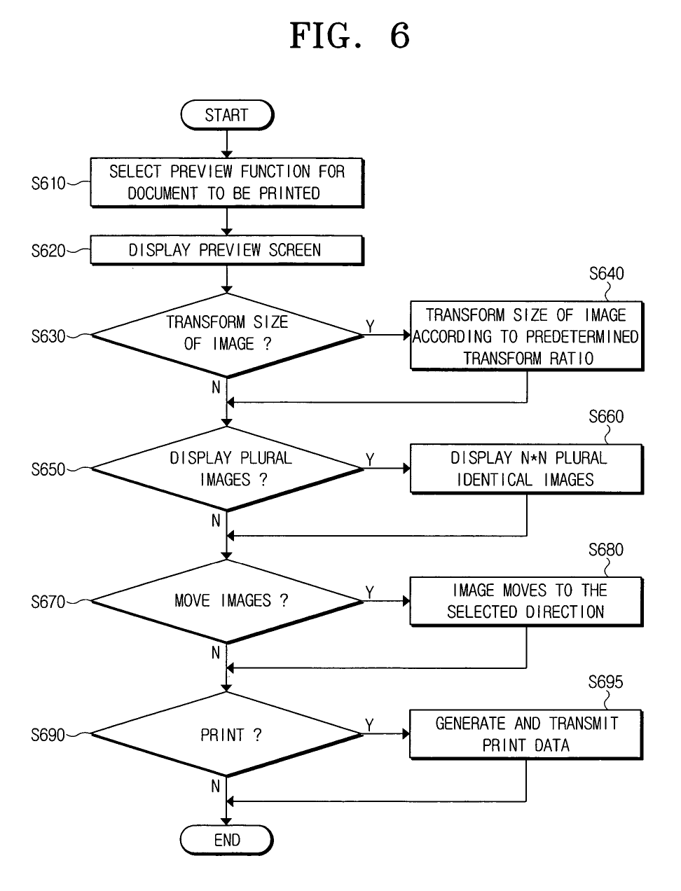

FIG. 6 is a flowchart of a method for printing according to an exemplary embodiment of the present invention. With reference to FIG. 6, at step S610, the user selects the preview function for the predetermined document, and the preview screen generating unit 130 generates the preview screen and displays the document image on the screen at step S620. At this time, the preview screen generating unit 130 might generate the preview screen by means of an application program or a printer driver program that corresponds to the printer which is connected to the terminal apparatus.

Next, at step S630, if the image size command is entered, then the size of the image might be enlarged or reduced according to the predetermined transform ratio at step S640. At this step, the user can personally select the transform ratio. When the printer has a borderless print function, the user may select borderless printing at the terminal apparatus. Thus, the user can enlarge or reduce the image size according to the size of the printing paper.

Next, at step S650, if the user enters the plural images display command, N*N images (as selected by the user) are displayed successively on the preview screen at step S660. When there is no demand to vary the size of an image or to display a plurality of images at the same time, the original image is displayed on the preview screen without change.

At step S670, if the user enters a location move command for the original image displayed on the preview screen, the image moves in the direction selected by the user at step S680. Therefore, the user can easily select the part to be printed while viewing the preview screen.

Next, at step S690, if the user enters a print command after moving the image, then print data is generated and transmitted to the printer at step S695. Thus, the user can print out a transformed image, as he or she desires.

The present invention enables a user to verify the shape of an image to be printed, move the image on the preview screen, and enlarge or reduce the size of image properly, thereby easily transforming an image to be printed so that images of a desired shape can be obtained all the time.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A terminal apparatus comprising:
a user interface unit for receiving a user selection command;
a preview screen generating unit for generating a preview image on a display screen by receiving a preview screen display command for a predetermined image through the user interface unit;
a display unit for displaying the preview screen; and
a control unit for controlling the preview screen generating unit to move the image displayed on the preview screen in a predetermined direction based on a move command entered through the user interface unit.

2. The terminal apparatus as claimed in claim 1, further comprising:
a data processing unit for converting image data displayed on the preview screen into predetermined print data based on a print command entered through the user interface unit; and
a printer interface unit which is capable of being connected to a printer for transmitting the print data to the printer.

3. The terminal apparatus as claimed in claim 2, wherein
the control unit controls the preview screen generating unit to transform the image displayed on the preview screen based on a command entered for transforming the image.

4. The terminal apparatus as claimed in claim 3, wherein
the control unit controls the preview screen generating unit to make one of the width and length of the image substantially the same as one of the width and length of the printing paper to be printed upon, based on a borderless display command entered for the image displayed on the preview screen.

5. The terminal apparatus as claimed in claim 3, wherein
the control unit controls the preview screen generating unit to display a plurality of substantially identical images successively on the preview screen based on a plural display command entered for the image displayed on the preview screen.

6. The terminal apparatus as claimed in claim 1, wherein
the preview screen generating unit generates the preview screen by one of a predetermined application program or a printer driver program.

7. A method for printing by a terminal apparatus connected to a printer, comprising the steps of:
generating a preview screen for an image;
moving the image on the preview screen based on a location move command;
converting the moved image data into print data that is recognizable by the printer; and
transmitting the print data to the printer.

8. The method as claimed in claim 7, further comprising the step of:
transforming the size of the image displayed on the preview screen by a predetermined transformation ratio based on a size transform command.

9. The method as claimed in claim 7, further comprising the steps of:
displaying the transformed image to make one of the width and length of the image substantially identical with one of the width and length of the printing paper to be printed based on a borderless display command; and
moving the image displayed on the preview screen in a predetermined direction based on the location move command.

10. The method as claimed in claim 7, further comprising the steps of:
displaying a plurality of substantially identical images successively on the preview screen based on a plurality of display commands; and
moving the image displayed on the preview screen in a predetermined direction based on the location move command.

11. The method as claimed in claim 7, wherein
the step of generating a preview screen is performed by one of a predetermined application program or a printer driver program.

12. A method for printing an image by a terminal apparatus connected to a printer, comprising the steps of:
(a) displaying a preview screen for the image on a display of the terminal apparatus;
(b) determining whether a size transform command has been entered, and, if so, transforming the size of the image according to a predetermined ration;
(c) determining whether a plurality of display commands has been entered, and, if so, displaying a plurality of substantially identical images;
(d) determining whether a location move command has been entered, and, if so, moving the image; and
(e) determining whether a print command has been entered, and, if so, sending print data to the printer to print the image.

13. The method as claimed in claim 11, wherein step (d) further comprises the step of:
determining the direction to move an image.

14. The method as claimed in claim 11, wherein
in step (e), the print data is generated by one of an application program or a printer driver program.

15. The method as claimed in claim 11, further comprising the step of:
determining whether a borderless print command has been entered, and, if so, transforming the size of the image so that one of the width or length of the enlarged image is substantially identical with one of the width or length of the printing paper.
